(19) United States
(12) Patent Application Publication
(10) Pub. No.: US 2026/0176502 A1
(43) Pub. Date: Jun. 25, 2026

(54) ADHESIVE TAPES FOR SHEATHED WIRE PROTECTION

(71) Applicant: Scapa Italia SpA, Ghislarengo (VC) (IT)

(72) Inventors: Angelo Leone, Ghislarengo (VC) (IT); Corrado Basile, Ghislarengo (VC) (IT)

(21) Appl. No.: 19/426,582

(22) Filed: Dec. 19, 2025

(30) Foreign Application Priority Data
Dec. 20, 2024 (IT) 102024000029565

(51) Int. Cl. C09J 7/38; C09J 5/00; C09J 7/25; H01B 3/44; H01B 7/00

(52) U.S. Cl. CPC C09J 7/385; C09J 5/00; C09J 7/255; H01B 3/441; C09J 2203/302; C09J 2301/416; C09J 2433/00; C09J 2467/006; H01B 7/0045

(57) ABSTRACT

An adhesive tape suitable for use with sheathed wires comprises a first layer of polyester and a second layer of adhesive. The adhesive includes a UV curable acrylic polymer and a cationic photoinitiator. The polyester is polyethylene terephthalate. The acrylic polymer contains an acrylic monomer selected from a specified group. The first layer has a thickness equal to or greater than 0.05 and equal to or less than 0.50 mm, preferably greater than 0.05 and equal to or less than 0.50 mm, more preferably equal to or greater than 0.15 and equal to or less than 0.30 mm, even more preferably equal to or greater than 0.018 and equal to or less than 0.22 mm. The adhesive is at least partially absorbed into the first layer. The second layer has a coating weight equal to or greater than 15 and equal to or less than 75 g/m², preferably equal to or greater than 20 and equal to or less than 60 g/m², more preferably equal to or greater than 30 and equal to or less than 50 g/m². The adhesive tape is wound about a cylindrical support to form a spool. The tape is applied to sheathed wires within an automotive engine, where each sheathed wire comprises a polypropylene sheath around a metal conductor, with the polypropylene sheath containing equal to or less than 1 weight % halogen.

### CROSS-REFERENCE TO RELATED APPLICATIONS

This application claims the benefit of Italian Application Serial No: 102024000029565, filed Dec. 20, 2024, the complete disclosure of which is incorporated herein by reference.

### TECHNICAL FIELD

This disclosure pertains to the field of adhesive tapes for high temperature applications, notably in automotive, electrical, and electronics industries.

### BACKGROUND

Hot melt pressure sensitive adhesive (HMPSA) tapes are used for a number of applications, such as wire protection in automative engines. Wires within automotive engines, for example Coficab™ sheathed wires, are subjected to extended periods of high heat. Conventional adhesive tapes may break down in such conditions, reducing adhesion.

In order to prevent adhesion issues, HMPSA compositions have previously been crosslinked to improve durability and cohesion. Conventionally, free radical crosslinkers have been used in UV conditions to achieve desired crosslinking. However, in some instances, free radical crosslinkers have been found to be chemically incompatible with sheathed wires most commonly used in the automotive engine industry and may result in migration of the adhesive into the wire sheaths, causing cracking or peeling thereof.

Therefore, there exists a need to produce a crosslinked adhesive tape which is chemically compatible with a broader range of sheathed wires and maintains sufficient adhesion in high temperature environments such as use within an automotive engine.

### SUMMARY

Accordingly, this description presents an adhesive tape and use thereof that addresses the aforementioned challenges by utilizing a polyester backing and adhesive layer comprising a UV curable acrylic polymer and cationic photoinitiator. By using a cationic photoinitator and a UV curable acrylic polymer adhesive, the adhesive tape provides a broader chemically compatible alternative for protecting sheathed wires in high temperature environments such as within an automotive engine.

### BRIEF DESCRIPTION OF DRAWINGS

FIG. 1 is a schematic of an example adhesive tape suitable for use with sheathed wires; and

FIG. 2 is a schematic of an example use of the adhesive tape, showing the adhesive tape applied to sheathed wires.

### DESCRIPTION OF EMBODIMENTS

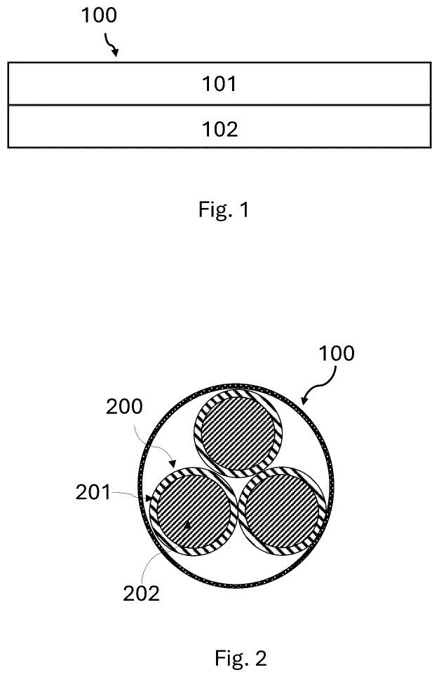

The adhesive tape 100 suitable for use with sheathed wires comprises a first layer 101 comprising polyester and a second layer 102 comprising adhesive (see FIG. 1). The adhesive comprises a UV curable acrylic polymer and a cationic photoinitiator.

Polyester is a category of polymers that contain an ester functional group in their main chain. It is commonly used in the production of fibers, films, and plastics, and is known for its durability, resistance to shrinking and stretching, and quick-drying properties. In the context of adhesive tapes, polyester, such as polyethylene terephthalate (PET), is often used as a base layer due to its strength and stability under high-temperature conditions.

UV curable refers to a material, typically an adhesive, coating, or resin, that undergoes a chemical reaction to harden or cure when exposed to ultraviolet (UV) light. This process involves the use of photoinitiators that absorb the UV light and initiate polymerization, resulting in a solidified material with enhanced mechanical and chemical properties.

Acrylic is a type of synthetic polymer derived from acrylic acid or related compounds. It is commonly used in a variety of applications, including adhesives, paints, and coatings, due to its excellent clarity, durability, and resistance to environmental factors such as UV light and weathering. Acrylic polymers can be formulated to be UV curable, making them suitable for high-performance adhesive tapes used in demanding environments like automotive engines.

A cationic photoinitiator is a type of photoinitiator that generates cations when exposed to light, typically ultraviolet (UV) light, to initiate a polymerization reaction. These cations can start the polymerization of monomers and oligomers, leading to the formation of a crosslinked polymer network. Cationic photoinitiators are often used in UV-curable adhesives and coatings due to their ability to provide rapid curing and improved chemical resistance.

The adhesive tape 100 provides a solution for high-temperature applications such as use within an engine cavity which ensures chemical compatibility between said sheathed wires and the adhesive tape 100. For example, high-temperature conditions include operating temperatures of 25-200 degrees C. for periods of time greater than one hour.

The present adhesive tape 100 is compatible with a wide range of sheath wires used in the automotive engine industry and as such does not require the user to know the composition of the sheath in order to ensure compatibility. This improves functionality of the adhesive tape 100 by preventing cracking or peeling and maintaining adhesion even under high temperature conditions. This also improves user experience and satisfaction by simplifying the adhesive tape application process by eliminating the need for an end user to know or predict the composition of the sheath to ensure sufficient protection via the adhesive tape 100.

The first layer 101 of the adhesive tape 100, comprising polyester, provides a durable and heat-resistant base that can withstand the high temperatures typically encountered in automotive engines. The use of polyester ensures that the tape maintains its structural integrity and adhesion properties even under prolonged exposure to elevated temperatures.

By incorporating a UV curable acrylic polymer and a cationic photoinitiator in the second layer 102, the adhesive tape 100 structure ensures that the adhesive can be effectively cured under UV light without the need for free radical crosslinkers which may otherwise migrate into the sheath and damage the adhesive tape and/or sheath under high temperature conditions. The adhesive tape 100 structure prevents such migration into the wires, thereby preventing or reducing cracking or peeling of the wire sheath. Furthermore, the UV curable acrylic polymer in the second layer 102 offers excellent adhesion and cohesion properties, ensuring that the tape remains securely attached to the sheathed wires that can endure the harsh conditions within an automotive engine.

Overall, the adhesive tape 100 construction enhances the reliability and longevity of sheathed wires in automotive applications.

In some embodiments, the polyester of the first layer 101 is polyethylene terephthalate (PET). By using polyethylene terephthalate (PET), the adhesive tape gains enhanced mechanical properties such as high tensile strength, excellent dimensional stability, and resistance to high temperatures. This makes the tape particularly suitable for use in automotive engines where it can withstand the harsh conditions without degrading, thereby ensuring long-term protection of the wires.

Additionally, PET's chemical resistance properties ensure that the adhesive tape does not react adversely with the sheathed wires, maintaining the integrity of both the tape and the wires over extended periods of high heat exposure.

In some embodiments, the acrylic polymer of the second layer 102 may be obtained through polymerization of an acrylic monomer selected from the group consisting of methyl acrylate, ethyl acrylate, ethyl methacrylate, methyl methacrylate, n-butyl acrylate, n-butyl methacrylate, n-pentyl acrylate, n-hexyl acrylate, n-heptyl acrylate, n-octyl acrylate, n-nonyl acrylate, lauryl methacrylate, cyclohexyl acrylate, i-butyl acrylate, i-butyl methacrylate, n-butyl methacrylate, 2-ethylhexylacrylate, stearyl methacrylate, isooctyl acrylate and their mixture.

The use of the above acrylic monomers in forming the acrylic polymer of the adhesive allows for the formulation of an adhesive with improved flexibility and durability of the second layer 102. This is particularly important in automotive applications where the adhesive tape must withstand vibrations, thermal expansion, and mechanical stresses without losing adhesion or cracking.

The specific acrylic monomers used in the polymer formulation are compatible with UV curing processes. This ensures efficient and complete curing of the adhesive under UV light, resulting in a robust and stable adhesive layer that maintains its properties over time.

The acrylic polymer's composition provides excellent resistance to chemicals and environmental factors, ensuring that the adhesive tape remains effective even in harsh conditions. This is crucial for maintaining the integrity of the wire sheath and preventing degradation due to exposure to automotive fluids and other chemicals.

In some embodiments, the cationic photoinitiator may be selected from the group consisting of diazonium salts, diaryliodonium salts, triarylsulfonium salts, alkylsulfonium salts, iron arene salts, sulfonyloxyketone, triarylsiloxysiloxane, and combinations thereof.

In some embodiments, the thickness of the first layer 101 is equal to or greater than 0.05 and equal to or less than 0.50 mm, preferably greater than 0.05 and equal to or less than 0.50 mm, more preferably equal to or greater than 0.15 and equal to or less than 0.30 mm, and even more preferably equal to or greater than 0.18 mm and equal to or less than 0.22 mm. The thickness of the first layer 101 is determined by ISO 5084 1996.

By choosing the thickness of the first layer 101 equal to or greater than 0.05 and equal to or less than 0.50 mm, preferably greater than 0.05 and equal to or less than 0.50 mm, more preferably equal to or greater than 0.15 and equal to or less than 0.30 mm, and even more preferably equal to or greater than 0.18 mm and equal to or less than 0.22 mm, the adhesive tape 100 ensures controlled mechanical strength and flexibility. This range of thickness provides a balance between durability and ease of application, which is crucial for maintaining the integrity of the wire sheath under high-temperature conditions found in automotive engines.

The defined thickness range also contributes to effective absorption of the adhesive into the first layer 101, enhancing the overall adhesion properties and preventing delamination or peeling of the adhesive tape 100 from the wire sheath surface. This is particularly important in high-stress environments where the adhesive tape 100 must remain securely attached to the wires to provide continuous protection.

In some embodiments, the adhesive is at least partially absorbed into the first layer 101. The at least partial absorption of the adhesive into the first layer 101 enhances the bond strength between the adhesive and the polyester of the first layer 101. This integration ensures that the second layer 102 remains securely attached to the first layer 101, even under high-temperature conditions, thereby preventing delamination or separation of the layers of the adhesive tape 100. This is particularly advantageous in automotive engine environments where the adhesive tape 100 is exposed to prolonged periods of high heat.

In preferred embodiments, the adhesive does not fully penetrate the first layer 101. This prevents or reduces lowering the adhesive strength of the adhesive tape 100. Penetration of the adhesive into the first layer 101 may be controlled during coating by controlling a process pressure and/or the distance between a die head dispensing the adhesive and the first layer 101.

In some embodiments, a coating weight of the second layer 102 is equal to or greater than 15 and equal to or less than 100 g/m², preferably equal to or greater than 20 and equal to or less than 90 g/m², more preferably equal to or greater than 30 and equal to or less than 80 g/m². Coating weight is determined by weighing the adhesive tape 100 before and after application of the second layer 102 and calculating the difference. By specifying that the coating weight of the second layer 102 is equal to or greater than 15 and equal to or less than 100 g/m², preferably equal to or greater than 20 and equal to or less than 90 g/m², and more preferably equal to or greater than 30 and equal to or less than 80 g/m², the adhesive tape 100 ensures controlled adhesion and durability under high-temperature conditions. This range of coating weight provides a balance between sufficient adhesive coverage and flexibility, preventing issues such as adhesive migration or insufficient bonding that could lead to wire insulation degradation.

This coating weight also contributes to effective absorption of the adhesive into the first layer 101, further enhancing the adhesive properties and preventing delamination or peeling of the adhesive tape 100 from the wire sheath surface. This is particularly important in high-stress environments where the adhesive tape 100 must remain securely attached to the wires to provide continuous protection.

In some embodiments, the adhesive tape 100 is wound about a core to form a spool for packaging and transport. By forming a spool, the adhesive tape 100 is maintained in a compact and organized form, which facilitates easy handling, storage, and application. This arrangement ensures that the adhesive tape 100 remains free from dust, debris, and other contaminants that could compromise its adhesive properties. Additionally, winding the adhesive tape 100 about a core helps in maintaining the integrity and uniformity of the second layer 102, preventing any premature exposure to environmental factors that could degrade its performance.

Another aspect provides for a use of the adhesive tape 100 wherein the adhesive tape 100 is applied to sheathed wires 200 within an automotive engine (see FIG. 2). In some embodiments, a plurality of sheathed wires 200 are bundled by the adhesive tape 100 over a length thereof. Although FIG. 2 shows three sheathed wires 200 in a bundle, the description is not limited thereto such that the adhesive tape 100 may be wrapped around any number of sheathed wires 200 based on user's need. In other embodiments, a single sheathed wire 200 may be wrapped by the adhesive tape 100. Applying the adhesive tape 100 to sheathed wires 200 within an automotive engine ensures that the sheathed wires 200 are protected from high temperatures and harsh environmental conditions. The use of a UV curable acrylic polymer with a cationic photoinitiator in the second layer 102 provides broader chemical compatibility with the sheaths of the sheathed wires 200, regardless of the material forming the sheaths, preventing issues such as migration of the adhesive into the sheathed wires 200, which can cause cracking or peeling of the sheaths. This provides a more reliable solution wherein end users are not required to know or predict the composition of the sheaths in order to ensure sufficient adhesion and protection of the sheathed wires by application of the adhesive tape 100. This results in improved durability and reliability of the sheathed wires over extended periods of high heat exposure and improved user satisfaction.

Furthermore, the adhesive tape 100 may maintain adhesion and integrity under high-temperature conditions to ensure that the sheathed wires 200 remain securely bundled and protected, reducing the risk of electrical failures or short circuits within the automotive engine. This contributes to the overall safety and performance of the vehicle's electrical system.

In some embodiments, each sheathed wire comprises a polypropylene sheath 201 around a metal core 202. This arrangement provides a robust and durable solution for wire protection, as the polypropylene sheath 201 offers excellent insulation and resistance to high temperatures while also reducing the risk of chemical interactions with the adhesive tape 100 or external environmental conditions due to the high chemical stability of polypropylene. The combination of the UV curable acrylic polymer adhesive and the cationic photoinitiator in the second layer 102 enhances adhesion and chemical compatibility with the polypropylene sheath, preventing issues such as cracking or peeling of the wires under high-temperature conditions.

In some embodiments, the polypropylene sheath 201 may comprise equal to or less than 2 weight % halogen, preferably equal to or less than 1 weight % halogen, and more preferably the polypropylene sheet may be halogen free. A thickness of the sheath may be equal to or greater than 0.18 and equal to or less than 0.50 mm, preferably equal to or greater than 0.20 and equal to or less than 0.40 mm.

### EXAMPLES

Example 1 was prepared comprising a first layer of polyethylene terephthalate (PET-SAP 15550), having an average thickness of 0.210 mm and a basis weight of 120 g/m², and a second layer of adhesive including an acrylic polymer and cationic photoinitiator (Loctite Duro-tack UV 6050), having a coating weight of 50 g/m².

Comparative Example 1 was prepared as Example 1, with the exception that the adhesive included an acrylic polymer and a free-radical photoinitiator (Loctite Duro-tack UV 21151).

Comparative Example 2 was prepared as Example 1, with the exception that the adhesive included an acrylic polymer and a free-radical photoinitiator (Loctite Duro-tack UV 4888).

### Compatibility Testing

Each of example 1 and comparative examples 1 and 2 were wrapped around sheathed wires (Coficab T3 PPZH A3ZP 0.35² and Coficab T3 PPZH A3TAH 0.35²). The wrapped wires were then subjected to three separate consecutive testing steps:
step 1) the wrapped wires were subjected to 150 degrees C. for 240 h
step 2) each wire was bent around a 10 mm diameter mandrel (Renault-Nissan procedure)
step 3) each tape was removed and the wires were separated into two wires. If the sheath remained intact after removal of the tape, one wire was wound twice around a 10 mm diameter mandrel (step
3A) and one wire was wound twice around a 2 mm diameter mandrel (step 3B).

The integrity of the tested wires were observed and are presented in Table 1:

| | Coficab T3 PPZH A3ZP 0.35² | | | | Coficab T3 PPZH A3TAH 0.35² | | | |
|---|---|---|---|---|---|---|---|---|
| | Step | Step | Step | Step | Step | Step | Step | Step |
| | 1 | 2 | 3A | 3B | 1 | 2 | 3A | 3B |
| Example 1 | ◯ | ◯ | ◯ | ◯ | ◯ | ◯ | ◯ | ◯ |
| Comparative | ◯ | ◯ | X | X | ◯ | ◯ | ◯ | ◯ |
| Example 1 | | | | | | | | |
| Comparative | ◯ | ◯ | X | X | ◯ | ◯ | X | X |
| Example 2 | | | | | | | | |

O denotes that the sheath maintained intact after removal of the tape and was successfully wrapped around mandrel
X denotes the sheath was destroyed, separated from, or degraded to the extent the wires could not be wrapped around the mandrel after tape removal

As seen by the results in Table 1, Example 1 demonstrated compatibility with both A3ZP and A3TAH wires and was removed from the sheath without damage or degradation. In contrast, comparative examples 1 and 2 failed to demonstrate compatibility with at least one of the tested wires, resulting in separation of the sheath from the wire after removal of the tape.

Persons skilled in the art will understand that the products and methods specifically described herein are non-limiting exemplary embodiments. The features illustrated or described in connection with one exemplary embodiment may be combined with the features of other embodiments. Various alternatives and modifications can be devised by those skilled in the art without departing from the disclosure. Accordingly, the disclosure is intended to embrace all such alternatives, modifications and variances. As well, one skilled in the art will appreciate further features and advantages of the disclosure based on the above-described embodiments. Accordingly, the disclosure is not to be limited by what has been particularly shown and described, except as indicated by the appended claims.

Hereby, all issued patents, published patent applications, and non-patent publications that are mentioned in this specification are herein incorporated by reference in their entirety for all purposes, to the same extent as if each individual issued patent, published patent application, or non-patent publication were specifically and individually indicated to be incorporated by reference.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of presently disclosed embodiments. Thus the scope of the embodiments should be determined by the appended claims and their legal equivalents, rather than by the examples given.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Various alternatives and modifications can be devised by those skilled in the art without departing from the disclosure. Accordingly, the disclosure is intended to embrace all such alternatives, modifications and variances. As well, one skilled in the art will appreciate further features and advantages of the disclosure based on the above-described embodiments. Accordingly, the disclosure is not to be limited by what has been particularly shown and described, except as indicated by the appended claims.

1. An adhesive tape suitable for use with sheathed wires comprising:
a first layer comprising polyester; and
a second layer comprising an adhesive, wherein the adhesive comprises a UV curable acrylic polymer and a cationic photoinitiator.

2. The adhesive tape suitable for use with sheathed wires of claim 1, wherein the polyester is polyethylene terephthalate.

3. The adhesive tape suitable for use with sheathed wires of claim 1, wherein the acrylic polymer is obtained through polymerization of an acrylic monomer selected from the group consisting of methyl acrylate, ethyl acrylate, ethyl methacrylate, methyl methacrylate, n-butyl acrylate, n-butyl methacrylate, n-pentyl acrylate, n-hexyl acrylate, n-heptyl acrylate, n-octyl acrylate, n-nonyl acrylate, lauryl methacrylate, cyclohexyl acrylate, i-butyl acrylate, i-butyl methacrylate, n-butyl methacrylate, 2-ethylhexylacrylate, stearyl methacrylate, and isooctyl acrylate.

4. The adhesive tape suitable for use with sheathed wires of claim 1, wherein the thickness of the first layer is equal to or greater than 0.05 and equal to or less than 0.50 mm.

5. The adhesive tape suitable for use with sheathed wires of claim 1, wherein the thickness of the first layer is equal to or greater than 0.15 and equal to or less than 0.30 mm.

6. The adhesive tape suitable for use with sheathed wires of claim 1, wherein the adhesive is at least partially absorbed into the first layer.

7. The adhesive tape suitable for use with sheathed wires of claim 1, wherein a coating weight of the second layer is equal to or greater than 15 and equal to or less than 100 g/m².

8. The adhesive tape suitable for use with sheathed wires of claim 1, wherein a coating weight of the second layer is equal to or greater than 20 and equal to or less than 90 g/m².

9. An adhesive spool comprising a core and the adhesive tape of claim 1 about the core.

10. A use of the adhesive tape of claim 1 for wrapping or binding one or more sheathed wires within an automotive engine.

11. The use of the adhesive tape suitable for use with sheathed wires of claim 10, wherein each sheathed wire comprises a metal core and a polypropylene sheath around the metal core.

12. The use of the adhesive tape suitable for use with sheathed wires of claim 11, wherein the thickness of the sheath is equal to or greater than 0.18 and equal to or less than 0.50 mm.

13. The use of the adhesive tape suitable for use with sheathed wires of claim 11, wherein each sheath wire has an outside diameter of equal to or greater than 1.20 and equal to or less than 5.20 mm.

14. The use of the adhesive tape suitable for use with sheathed wires of claim 11, wherein the sheathed wires sustain voltage of at least 600 V ac or at least 1000 V dc.
